(19) United States
(12) Patent Application Publication
(10) Pub. No.: US 2012/0249947 A1
(43) Pub. Date: Oct. 4, 2012

(54) SIDE SHIELD CONNECTION OF SAFETY GLASSES

(76) Inventor: Brent SHELDON, Montreal (CA)

(21) Appl. No.: 13/076,991

(22) Filed: Mar. 31, 2011

(51) Int. Cl. G02C 5/14; G02C 13/00

(52) U.S. Cl. 351/121; 351/178

(57) ABSTRACT

Eye glasses having side shields include a frame with at least one lens attached to the frame. A pair of temples is pivotally connected to the respective opposed side ends of the frame, each of the temples including a first substantially transparent portion to provide one of the side shields. The first portion is permanently engaged with a second portion of each of the temples during the formation of the temple in a molding procedure.

### TECHNICAL FIELD

The present invention relates to eyewear, and more particularly to eye glasses having side shields and to a method for providing side shields to eye glasses.

### BACKGROUND OF THE INVENTION

Safety glasses conventionally include side shields positioned at opposite side ends of the glasses to prevent debris and other foreign objects from entering the space between the lenses and the user's eyes. In particular, when optical lenses are required, the glasses' front section is usually in a relatively flat configuration and does not provide a curvature which contours to the user's face, thereby creating larger open areas at the opposite end sides of the glasses to allow debris and foreign objects to enter the space between the lenses and the user's eyes. Therefore, side shields are even more desirable for safety glasses having optical lenses. The side shields are conventionally transparent in order to allow better peripheral vision for the user. Conventionally, these side shields are detachably connected to eyeglasses, for example to the temple pieces. However, detachable connection of side shields to eye glasses usually requires additional connection structures which increase manufacturing costs. The conventional detachable connection of side shields to eye glasses may not provide adequate connection, which may cause accidental disconnection of the side shields. In some circumstances eye glasses having side shields may be damaged due to a weak connection of the side shields.

Accordingly, there is a need for improvement of side shield connection of eye glasses.

### SUMMARY OF THE INVENTION

In accordance with one aspect of the present invention, there is provided eye glasses having side shields comprising a frame with at least one lens attached to the frame, a pair of temples pivotally connected to respective opposed side ends of the frame, each of the temples including a first substantially transparent portion to provide one of said side shields, the first portion being permanently engaged with a second portion of each of the temples during formation of the temple in a molding procedure.

In accordance with another aspect of the present invention there is provided a method for proving side shields to eye glasses comprising: a) providing a pre-fabricated one of a first temple and a substantially transparent side shield and providing a molding device; b) placing the pre-fabricated one of the first temple and the first side shield in a predetermined position with respect to the molding device such that a portion of the molding device overlaps a portion of said pre-fabricated one of the first temple and the first side shield; c) forming the first temple with permanent engagement of the first substantially transparent side shield thereto by injecting a molding material into the molding device; d) forming a second temple with permanent engagement of a second substantially transparent side shield in steps similar to steps a, b and c; and e) pivotally connecting the respective first and second temples to opposed side ends of a frame of the eye glasses to which at least one lens is attached.

Other features and advantages of the present invention will be better understood with reference to the preferred embodiments described hereinafter.

### BRIEF DESCRIPTION OF THE DRAWINGS

Having thus generally described the nature of the present invention, reference will now be made to the accompanying drawings, showing by way of illustration the preferred embodiments thereof, in which:

FIG. 1 is a side elevational view of eye glasses according to one embodiment, showing a side shield permanently attached to a temple of the eye glasses;

FIG. 2 is a front elevational view of the eye glasses of FIG. 1;

FIG. 3 is a cross-sectional view of the eye glasses of FIG. 1, taken along line 3-3 showing a structure and method of attachment of the side shield to the temple during the formation of the temple;

FIG. 4 is a side elevational view of the eye glasses according to another embodiment of the present invention;

FIG. 5 is a cross-sectional view of the eye glasses of FIG. 4, taken along line 5-5, showing an optional feature of the temple;

FIG. 6 is a perspective view of a pair of eye glasses according to a further embodiment of the present invention;

FIG. 7 is a partial cross-sectional view of the eye glasses of FIG. 6, taken along line 7-7, showing an alternative structure and method for permanently attaching the shield to the temple during the formation of the temple;

FIGS. 8, 9 and 10, each in a partial cross-sectional view of the eye glasses of FIG. 6 similar to FIG. 7, illustrate further alternative structures of the permanent attachment of the side shield to the temple during formation of the temple; and

FIG. 11 is a cross-sectional view of a temple of eye glasses according to a further embodiment

### DETAILED DESCRIPTION OF THE PREFERRED EMBODIMENTS

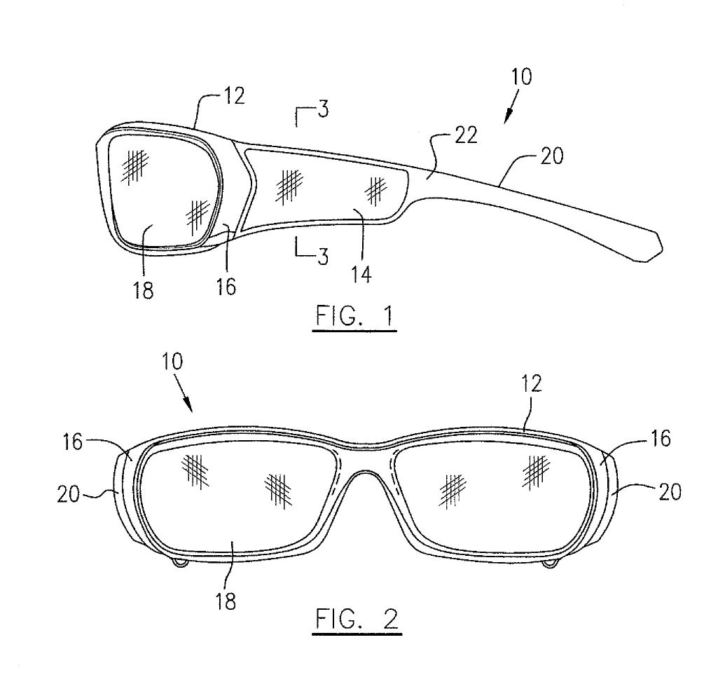

Referring to FIGS. 1 and 2, eye glasses 10 according to one embodiment generally include a frame 12 which for example may be made of a plastic material in a molding process, having opposed side ends 16 for supporting one or two lenses 18 attached thereto. A pair of temples 20 are pivotally connected to the respective opposed side ends 16 of the frame 12 in a conventional manner. Each of the temples 20 includes a substantially transparent side shield 14 permanently attached to the temple 20. The side shield 14 according to one embodiment substantially forms an integral wide front end section of the temple 20. The side section 14 in this embodiment may be a piece of glass or plastic lens which may be rigid or semi-rigid and is surrounded by a rigid plastic material which forms a remaining portion 22 of the temple 20. The rigid plastic material of the remaining portion 22 forms a narrow and elongate rear end section (not indicated) of the temple 20, smoothly extending rearwardly from the relatively wider front end section to define an aperture (not indicated) for receiving the substantially transparent side shield 14 therein. Therefore, the entire peripheral edge of the side shield 14 is surrounded by the rigid plastic material of the remaining portion 22.

The permanent attachment of the side shield 14 to the temple 20 is achieved during formation of the temple 20 and therefore, the side shield 14 cannot be removed from the temple 20 or re-attached thereto by a conventional “click out” or “click in” action which is usually used for removably attaching lenses to frames of eye glasses. The eye glasses 10 are symmetrical about a central axis (not indicated) and the left and right halves of the eye glasses 10 including the left and right temples 20, are substantially identical but in a mirror image of each other. Therefore, the following description of the various embodiments of the temple structure and the method for permanent attachment of the side shield 14 to the temple 20 will be simplified by making reference to only one side shield attachment to one temple of the eye glasses 10. It should be understood that permanent attachment of the other side shield to the other temple of the eye glasses is achieved by substantially repeating the steps described below.

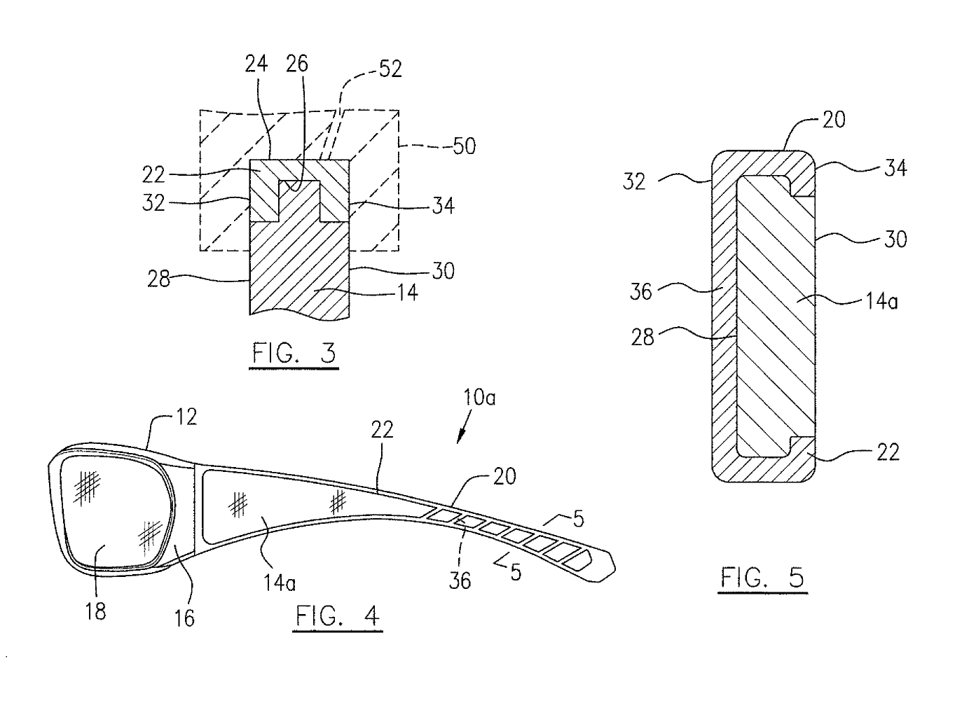

Referring to FIGS. 1 and 3, a molding device 50 indicated with a broken line representing a partial section thereof, defines a cavity 24 in accordance with a configuration of the remaining portion 22 (made of the rigid plastic material) of the temple 20 and includes a molding injection passage 52 communicating with the cavity 24 in order to permit injection of the rigid plastic material in an appropriate state, into the cavity 24 during a formation molding procedure.

The side shield 14 which is pre-fabricated, is placed in a predetermined position with respect to the molding device 50 such that at least a portion of the molding device 50 overlaps a portion of the side shield 20 and thus the side shield 20 closes major openings of the cavity 24 of the molding device 50, except the molding injection passage 52 and air escape passages (not shown). When the side shield 20 is placed and held by tools (not shown) in this predetermined position and thus closes the major openings of the cavity 24 of the molding device 50, the formation molding procedure begins and the cavity 24 is filled with the plastic material in an appropriate state, which then becomes rigid, thereby forming the substantially rigid temple 20 with the rigid plastic material of the remaining portion 22 permanently engaging with the side shield 14.

In this embodiment the cavity 24 of the molding device 50 is designed such that a continuous portion of the molding device overlaps an entire peripheral edge 26 of the side shield 14 at both sides of the side shield 14, thereby forming the temple 20 with an annular groove (not indicated) defined therein to receive the entire peripheral edge 26 of the side shield 14. The annular groove has a depth sufficient to permanently engage the entire peripheral edge 26 of the side shield 14.

Optionally, the side shield 14 has a peripheral area thinner than the remaining portion thereof such that opposite inner and outer sides 28, 30 of the side shield 14 are flush with respective opposite inner and outer sides 32, 34 of the remaining portion 22 of the temple 20, thereby providing a smooth surface at both sides of the temple 20.

Alternatively, the annular groove may be discontinuous and broken into a number of groove sections. Each of the groove sections functions as a pair of retainers holding the side shield 14 in position, as fully described in Applicant's U.S. Pat. No. 6,899,427, issued on May 31, 2005 which is incorporated herein by reference.

FIG. 4 illustrates another embodiment of the present invention in which a pair of eye glasses 10a includes components and features similar to those of the eye glasses 10 shown in FIGS. 1-3 and are indicated by similar numerals. Those similar components and features will not be redundantly described herein. The difference between the eye glasses 10a and the eye glasses 10 of FIGS. 1-3 substantially lies in the shape of the side shield 14a. The side shield 14a which is substantially transparent and rigid, not only forms a major area of the front end section of the temple 20 but also extends to the rear end section of the temple 20, having a profile substantially similar but smaller than the temple 20. Therefore, a remaining portion 22 of the temple 20 which is formed of the rigid plastic material surrounding the entire peripheral edge of the side shield 14a, forms a continuous narrow peripheral strip of the temple 20.

In this embodiment, the substantially transparent and rigid side shield 14a provides rigidity of the entire temple 20 and therefore, the remaining portion 22 of the temple 20 may be optionally formed with a molding material which is softer than the rigid side shield 14a, such as a rubber material to form the narrow peripheral strip of the temple 20, thereby providing comfortability and holding friction when the eye glasses 10a are in use.

Optionally, at the rear end section of the temple 20 a plurality of ribs 36 may be provided at the inner side 32 of the temple 20, interconnecting the peripheral strip sections of the remaining portion 22 at the respective top and bottom peripheral edges of the side shield 14a, as shown in FIG. 5. The ribs 36 and the narrow strip which together define the remaining portion 22 of the temple 20, are formed of the softer molding material during the formation of the temple 20, in the method as described above. The ribs 36 at the inner side 32 of the rear end section of the temple 20, provide more comfortability and holding friction of the temple 20.

Optionally, in contrast to the temple 20 of the eye glasses 10 which provides a smooth inner surface of the temple 20 by having the inner side 28 of the side shield 14 and the inner side 32 of the remaining portion 22 of the temple 20 in a flush condition as shown in FIG. 3, the inner side 32 of the remaining portion 22 of the temple 20 including the ribs 36, may slightly project from the inner side 28 of the side shield 14a as shown in FIG. 5.

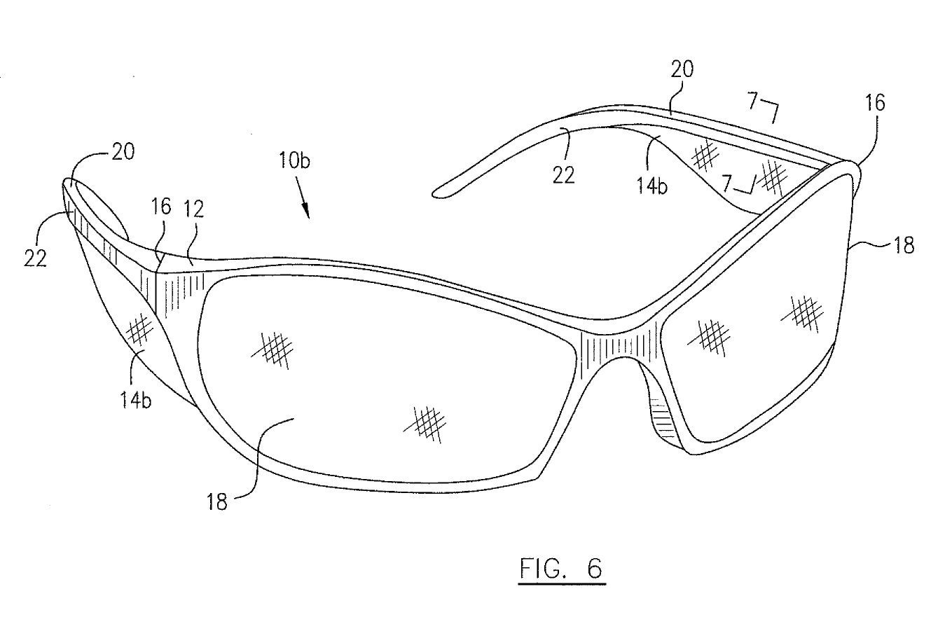

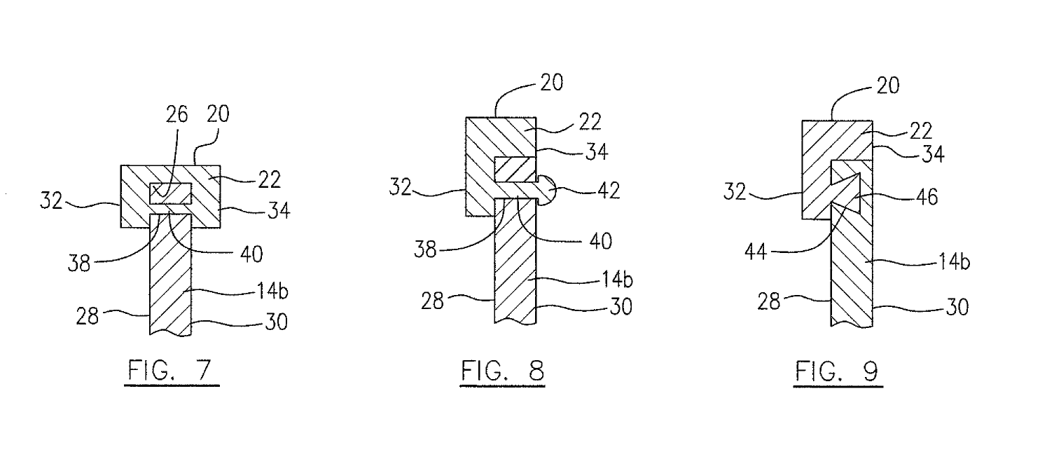

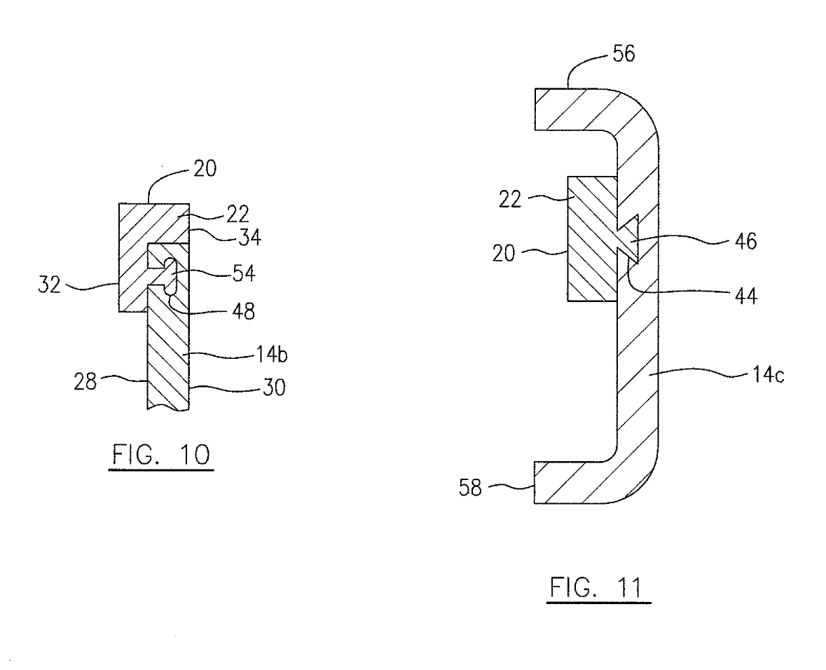

FIGS. 6-10 illustrate a further embodiment in which eye glasses 10b include components and features similar to those of eye glasses 10 shown in FIGS. 1-3, which are indicated with similar numerals, and which will not be redundantly described herein. The difference between the eye glasses 10b and the eye glasses 10 of FIGS. 1-3 substantially lies in the attachment of the side shields to the respective temples in various alternative structural arrangements as shown in FIGS. 7-10. The permanent attachment of side shields 14b to the respective temples 20 are also achieved during the formation of each temple using a molding device (not shown) in a molding procedure, similarly as previously described with reference to FIG. 3. However, instead of the entire peripheral edge of each side shield 14 being surrounded and thus permanently engaged with the remaining portion 22 of the temple 20, as are the eye glasses 10 as shown in FIG. 1, each of side shields 14b of eye glasses 10b defines at least one hollow space, such as a plurality of holes 38 in FIGS. 7 and 8 or a groove 44 or 48 in FIG. 9 or 10, permanently engaging part of the second portion 22 of the temple 20. It should be understood that the at least one hollow space is defined in a portion of the side shield 14b which is overlapped by a portion of the molding device (not shown) similar to the molding device 50 in FIG. 3 such that a portion of the rigid plastic material in an appropriate state, is filled into the at least one hollow space during the formation of each of the temples 20.

In this embodiment of FIGS. 6-10, the remaining portion 22 of the temple 20 is substantially elongate, extending from a front end to a rear end of the temple 20. The substantially rigid and transparent side shield 14b is permanently attached only at its top edge to the front section of the remaining portion 22 of the temple 20. A plurality of holes 38 are located in a top edge area and extend between opposite sides 28 and 30 of the side shield 14b. During a molding procedure of the temple 20, the top edge area of the side shield 14b defining the holes 38 therein, is overlapped by a portion of a molding device (not shown) similar to the molding device 50 of FIG. 3 such that a portion of the rigid plastic material in an appropriate state which forms the rigid remaining portion 22 of the temple 20, is filled into the holes 38, thereby forming a plurality of studs 40 integrated with the remaining portion 22 of the temple 20 and extending through the holes 38. Therefore, the top edge area of the peripheral edge 26 of the side shield 14b is received in a groove defined in the remaining portion 22 of the temple 20 and is permanently engaged by the plurality of studs 40 extending across the groove in the remaining portion 22 of the temple 20.

Alternatively, as shown in FIG. 8, the remaining portion 22 of the temple 20 does not define a groove to receive the top edge area of the side shield 14b. Instead, each of the studs 40 which are integrated with the remaining portion 22 of the temple 20 only at one side (for example at the inner side 28 of the side shield 14b), extends into the holes 40 defined in the side shield 14b, terminating at an enlarged end 42 thereof which has a size greater than the diameter of the hole 38. Therefore the studs 40 permanently engage the side shield 14b.

Alternatively as shown in FIG. 9, the at least one hollow space defined in, for example the top edge area of the side shield 14b, is a groove 44 extending substantially along the top edge of the side shield 14b. The groove 44 has an opening at one side, for example the inner side 28 of the side shield 14b, which allows a portion of the rigid plastic material of the remaining portion 22 of the temple 20, in an appropriate state, to be filled into the groove 44 during the formation molding procedure of the temple 20, thereby forming a projecting member 46 which is integrated with the remaining portion 22 of the temple 20 and is engaged with the groove 44 defined in the side shield 14b. The opening of the groove 44 has a width smaller than the width of the bottom of the groove and therefore, the projecting member 46 which has a complementary cross-sectional profile, is prevented from withdrawal from the groove 44.

Alternatively, the groove 44 can have any other appropriate cross-sectional configuration, provided the opening width is smaller than the bottom width of the groove 44. For example, the groove 48 illustrated in FIG. 10 has a T-shaped cross-sectional configuration. A projecting member 54 has a complementary T-shaped cross-section formed during the formation molding procedure of the temple 20 and is permanently engaged within the T-shaped groove 48 of the side shield 14b.

It should be understood that the above-described embodiments are taken as examples of the application of the present invention, but do not limit the present invention to the particular shapes and configurations of the components illustrated in the accompanying drawings and described herein. For example, a side shield 14c as illustrated in FIG. 11 which forms part of the temple 20, may have inwardly curved top and bottom portions 56, 58. The side shield 14c is permanently attached at its middle area rather than at a peripheral edge area to a front end section of the remaining portion 22 of the temple 20, with an engagement structure similar to that illustrated in FIG. 9, which will not be redundantly described herein.

Alternatively, a pre-fabricated temple, for example similar to the remaining portion 22 of the temple 20 of the glasses 10b shown in FIG. 6, rather than the side shield 14b, may be placed in a predetermined position with respect to a molding device designed for this particular molding procedure. The molding procedure is similar to the molding procedure as described with reference to the previous embodiments. The molding material to be injected into the molding device, however, for example is a plastic material in an appropriate state which forms the substantially transparent side shields. When the molding material is cured, the substantially transparent side shield 14b is permanently engaged with the pre-fabricated remaining portion 22 of the temple 20. Various engagement structures which may or may not be similar to those previously described, will be applicable to the molding procedure using either the prefabricated one of the temple portion and the side shield portion.

Modifications and improvements to the above-described embodiments of the present invention may become apparent to those skilled in the art. For example, the described invention may be applied to eye glasses with temples of various types, fashions and uses, different from those illustrated in the accompanying drawings. The materials forming the respective temple portion, side shield portion and frame for holding the lenses, are not limited to those mentioned in the described embodiments. The respective temple portion, side shield portion and frame may be rigid or flexible. The foregoing description is intended to be exemplary rather than limiting. The scope of the present invention is therefore intended to be limited solely by the scope of the appended claims.

I/We claim:

1. Eye glasses having side shields comprising a frame with at least one lens attached to the frame, a pair of temples pivotally connected to respective opposed side ends of the frame, each of the temples including a first substantially transparent portion to provide one of said side shields, the first portion being permanently engaged with a second portion of each of the temples during formation of the temple in a molding procedure.

2. The eye glasses as defined in claim 1 wherein an entire peripheral edge of the first substantially transparent portion is surrounded by the second portion of the temple.

3. The eye glasses as defined in claim 2 wherein the second portion of the temple comprises an annular groove for permanent engagement with the entire peripheral edge of the first substantially transparent portion.

4. The eye glasses as defined in claim 2 wherein the first substantially transparent portion has a profile substantially similar to and smaller than the temple.

5. The eye glasses as defined in claim 4 wherein the first substantially transparent portion is substantially rigid.

6. The eye glasses as defined in claim 5 wherein the second portion of the temple is softer than the first substantially transparent portion.

7. The eye glasses as defined in claim 1 wherein the first substantially transparent portion comprises at least one hollow space, the at least one hollow space permanently engaging part of the second portion of the temple.

8. The eye glasses as defined in claim 1 wherein the first and second portions of the temple are substantially rigid.

9. The eye glasses as defined in claim 1 wherein the eye glasses comprise a pair of optical lenses.

10. The eye glasses as defined in claim 1 wherein the first substantially transparent portion of the pair of the temples is tinted with colour.

11. A method for proving side shields to eye glasses comprising:
a) providing a pre-fabricated one of a first temple and a substantially transparent side shield and providing a molding device;
b) placing the pre-fabricated one of the first temple and the first side shield in a predetermined position with respect to the molding device such that a portion of the molding device overlaps a portion of said pre-fabricated one of the first temple and the first side shield;
c) forming the first temple with permanent engagement of the first substantially transparent side shield thereto by injecting a molding material into the molding device;
d) forming a second temple with permanent engagement of a second substantially transparent side shield in steps similar to steps a, b and c; and
e) pivotally connecting the respective first and second temples to opposed side ends of a frame of the eye glasses to which at least one lens is attached.

12. The method as defined in claim 11 wherein in step (b) the pre-fabricated one is the first substantially transparent side shield and wherein in step (c) the injected molding material is a material which forms the first temple.

13. The method as defined in claim 11 wherein in step (b) the pre-fabricated one is the first temple and wherein in step (c) the injected molding material is a material which forms the first substantially transparent side shield.

14. The method as defined in claim 12 wherein a continuous portion of the molding device overlaps an entire peripheral edge of the first side shield at both sides of the first side shield such that the first temple is formed with an annular groove defined therein, the annular groove having a depth sufficient to permanently engage the entire peripheral edge of the first side shield.

15. The method as defined in claim 12 wherein the first side shield defines at least one hollow space in the portion thereof which the portion of the molding device overlaps such that a portion of the molding material is filled into the at least one hollow space during the forming step of the first temple.
